(19) United States
(12) Patent Application Publication
(10) Pub. No.: US 2005/0236957 A1
(43) Pub. Date: Oct. 27, 2005

(54) Color cathode ray tube

(75) Inventor: Kwang Soo Son, Daegukwangyeok-Si (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kumi-Si (KR)

(21) Appl. No.: 11/075,804

(22) Filed: Mar. 10, 2005

(30) Foreign Application Priority Data
Mar. 12, 2004 (KR) 2004-16841

(51) Int. Cl. H01J 29/86; H01J 29/80; H01J 61/30; H01J 29/92

(52) U.S. Cl. 313/477 R; 220/2.1 A; 220/2.1 R

(57) ABSTRACT

A color cathode ray tube comprising a panel, an outer surface of which is flat and an inner surface of which has a designated curvature. Since the panel has a thickness (CFT) of a central portion thereof satisfying the range of 9.0 mm≦CFT≦10.9 mm, and a light transmittance (Tp) of the central portion thereof satisfying the range of 50%≦Tp≦65%, the color cathode ray tube reduces the weight of the panel and thermal damage generated in a color cathode ray tube manufacturing process, and improves brightness of the panel.

### BACKGROUND OF THE INVENTION

1. Field of the Invention

The present invention relates to a color cathode ray tube, and more particularly to a color cathode ray tube having an improved structure of a panel applied thereto, thereby preventing damage generated due to a thermal treatment process and reducing the weight of the panel.

2. Description of the Related Art

FIG. 1 is a sectional view illustrating a structure of a conventional color cathode ray tube.

With reference to FIG. 1, the conventional color cathode ray tube comprises a front panel 1 made of glass, a rear panel 2 made of glass, a shadow mask 3 for selecting an electron beam 9 discharged from an electron beam gun, and a deflection yoke 8 for scanning the electron beam 9 up, down, right, and left.

The deflection yoke 8 includes a plurality of coils and electromagnets, and scans the electron beam 9, which was discharged from the electron beam gun, up, down, right, and left so that an electric signal is reproduced into a two-dimensional image by the cathode ray tube.

The shadow mask 3 includes a plurality of slots for passing the electron beam 9 so that the electron beam 9 having three colors of red (R), green (G), and blue (B) suitably reaches a fluorescent substance coating a screen 4 formed in the panel 1. In order to install the shadow mask 3 on the panel 1, a frame 5 supporting the shadow mask 3, a spring 6, and a stud pin 7 are connected and installed in the panel 1.

The panel 1, which corresponds to a screen, forms a portion of a vacuum container and converts image data into final visual data. As shown in FIG. 2, which is a sectional view of the panel 1, the panel 1 applied to the conventional cathode ray tube has a convex structure such that inner and outer surfaces of the panel 1 have a designated curvature.

When a viewer at the outside watches the screen, the above panel 1 having the convex structure generates a distorted image or a problem of the image due to the reflection of light. In order to solve the above problems, the conventional cathode ray tube has been replaced with a flat panel type cathode ray tube, in which the flatness of the outer surface of the panel 1 is improved.

FIG. 3 is a sectional view of a panel having a flat outer surface. The outer surface of the above panel 1 is flat. However, since the inner surface of this panel 1 relates to explosion-proof characteristics of the panel 1 and plasticity of the shadow mask 3, the inner surface of the panel 1 has a designated curvature.

As the panel 1 has an increased size and is flattened, the thickness of the panel 1 of the above-described color cathode ray tube is gradually increased from the central portion to the edge portion. Accordingly, stress applied to the panel 1 by thermal strain of the inner and outer surfaces of the panel 1 exceeds a limit stress due to a difference of thermal conductivities between the central portion and the edge portion of the panel 1 in a thermal treatment process for manufacturing the color cathode ray tube, thereby damaging or breaking the panel 1.

Further, in terms of screen characteristics of the cathode ray tube, when the panel 1 has an increased thickness, the brightness of the screen is deteriorated. In order to increase the deteriorated brightness of the screen to an original level, the widths of the fluorescent substances coating the screen must be increased.

However, since the above cathode ray tube has a limited effective screen size, widths of black matrix for dividing the fluorescent substances must be decreased in order to increase the widths of the fluorescent substances. The increase in the widths of the fluorescent substances coating the screen deteriorates color purity.

### SUMMARY OF THE INVENTION

Therefore, the present invention has been made in view of the above problems, and it is an object of the present invention to provide a color cathode ray tube, which comprises a panel having an improved structure, an outer surface of which is flat and an inner surface of which has a designated curvature, thereby reducing damage degenerated in a thermal treatment process for manufacturing the color cathode ray tube and increasing brightness of the panel due to decrease in the thickness of the panel.

In accordance with the present invention, the above and other objects can be accomplished by the provision of a color cathode ray tube comprising: a front panel, an outer surface of which is flat and an inner surface of which has a designated curvature; a rear panel installed on a rear part of the front panel for forming vacuum therein; an electron beam gun inserted into a neck part of the rear panel for discharging an electron beam toward a screen; a deflection yoke for scanning the electron beam, discharged from the electron beam gun, up, down, right, and left; and a shadow mask, formed on the inner surface of the front panel, including a plurality of slots spaced from each other by a designated interval, wherein a thickness (CFT) of a central portion of the front panel satisfies the below range: 9.0 mm≦CFT≦10.9 mm, and a light transmittance (Tp) of the central portion of the front panel satisfies the below range: 50%≦Tp≦65%.

Preferably, a thickness (Tf) of an end of an effective screen of the front panel may satisfy the below range: 18.0 mm≦Tf≦26.0 mm.

Further, preferably, a distance (OAH) between a central portion of the outer surface of the front panel and a contact portion of the front and rear panels may satisfy the below range: 75 mm≦OAH≦95 mm, and a distance (Pz) between a stud pin, for connecting the front panel and a frame supporting the shadow mask, and a central portion of the inner surface of the front panel may satisfy the below range: 40 mm≦Pz≦60 mm.

Moreover, the shadow mask may be made of invar or ultra invar, and a thickness (Ts) of the shadow mask may satisfy the below range: 0.19 mm≦Ts≦0.21 mm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a structure of a conventional color cathode ray tube;

FIG. 2 is a sectional view of a panel applied to the conventional color cathode ray tube;

FIG. 3 is a sectional view of a panel having a flat outer surface;

FIG. 4 is a sectional view of a panel applied to a color cathode ray tube in accordance with the present invention;

FIG. 5 is a sectional view of the panel illustrating a distance between a stud pin and the inner surface of the panel;

FIG. 6 is a perspective view of a shadow mask, which is applied to the color cathode ray tube of the present invention; and

FIG. 7 is a sectional view of FIG. 6, taken along the “z” axis.

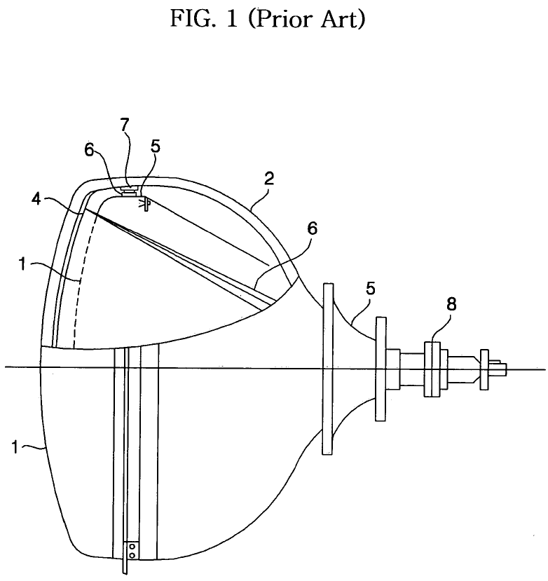

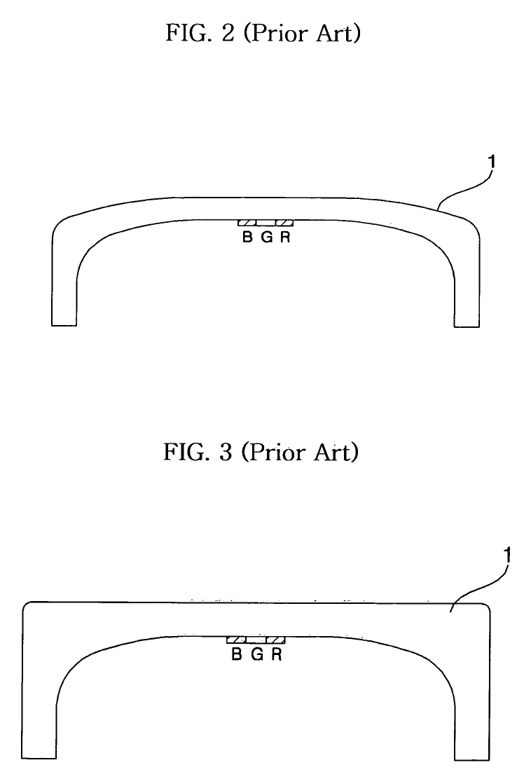

### DESCRIPTION OF THE PREFERRED EMBODIMENTS

Now, a preferred embodiment of the present invention will be described in detail with reference to the annexed drawings. In the following description made in conjunction with the preferred embodiment of the present invention, the same or similar elements are denoted by the same reference numerals even through they are depicted in different drawings.

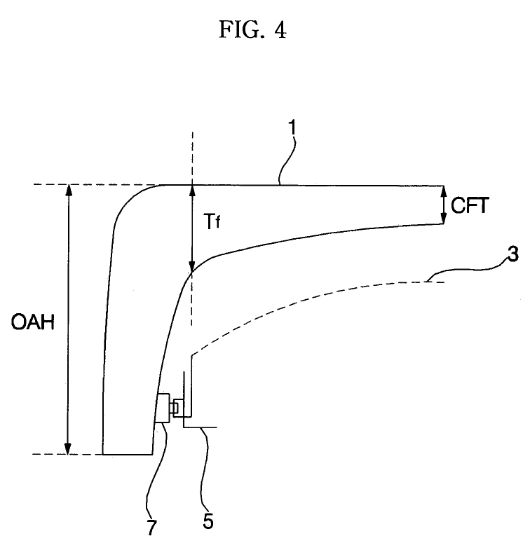

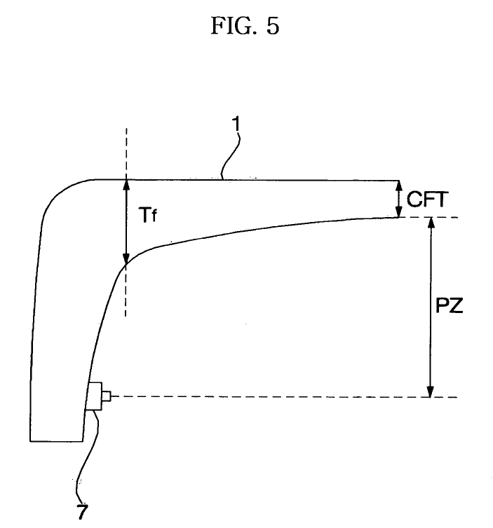

FIG. 4 is a sectional view of a panel applied to a color cathode ray tube in accordance with the present invention, and FIG. 5 is a sectional view of the panel illustrating a distance between a stud pin and the inner surface of the panel.

The panel 1, which is applied to the color cathode ray tube, corresponds to a screen for converting image data into final visual data, and is configured such that the outer surface of the panel 1 is flat, the inner surface of the panel 1 has a designated curvature, the thickness (CFT) at a central portion of the panel 1 is in the range of 9.0 mm to 10.9 mm, and the light transmittance (Tp) at the central portion of the panel 1 is in the range of 50% to 65%.

The small thickness (CFT) at the central portion of the panel 1 is advantageous to the light-weight and the cost reduction of the color cathode ray tube. In a general color cathode ray tube, since an upper limit of the value of X-ray discharged through the panel 1 is standardized, the reduction of the thickness (CFT) at the central portion of the panel 1 is limited.

Accordingly, the thickness at the central portion of the panel 1, which is applied to the conventional color cathode ray tube, has the minimum value of 10.9 mm due to the above limit of the value of the X-ray. However, the thickness at the central portion of the panel 1, which is applied to the color cathode ray tube of the present invention, is adjusted by changing the composition of a heavy metal used as a raw material of the panel 1. Here, in the case that the thickness of the panel 1 is smaller than 9.0 mm, the weight ratio of the heavy metal of the panel 1 is increased, thereby increasing the weight of the panel 1 due to the specific gravity of the heavy metal even when the thickness at the central portion of the panel 1 is reduced.

Further, the cost of the panel 1 is increased by the increase in the cost of the heavy metal. Accordingly, the thickness (CFT) at the central portion of the panel 1 is in the range of 9.0 mm to 10.9 mm, and preferably, in the range of 9.2 mm to 10.33 mm.

Thereby, it is possible to solve the deterioration in brightness characteristics of the flat panel 1 applied to the color cathode ray tub of the present invention, which is caused by the large thickness (CFT) at the central portion of the is panel 1 having a transmittance of 50% to 65%. That is, in the case that the thickness (CFT) at the central portion of the flat panel 1 applied to the color cathode ray tube of the present invention is reduced to the above-described range, the brightness of the flat panel 1 applied to the color cathode ray tube of the present invention is increased by approximately 8% to 18% compared to the brightness of the panel applied to the conventional color cathode ray tube.

Preferably, the thickness (Tf) at an end of the effective screen of the panel 1 applied to the color cathode ray tube of the present invention is in the range of 18.00 mm to 26.00 mm (i.e., 18.00 mm≦Tf≦26.0 mm).

In the case that the thickness (Tf) at the end of the effective screen of the panel 1 is smaller than 18.0 mm, vacuum stress applied to the end of the effective screen of the panel 1 is increased, thereby deteriorating explosion-proof characteristics of the panel 1, serving as safety characteristics of the panel 1.

On the other hand, in the case that the thickness (Tf) at the end of the effective screen of the panel 1 is larger than 26.0 mm, thermal stress is generated by the thermal distortion of the inner and outer surfaces of the panel 1 due to a difference of thermal conductivities between the central portion and end portion of the panel 1 in a furnace in the process for manufacturing the cathode ray tube. A portion of the panel 1, on which the thermal stress is concentrated, is easily broken by external impact.

Accordingly, the thickness (Tf) at the end of the effective screen of the panel 1 is in the range of 18.0 mm to 26.0 mm, and preferably in the range of 20 mm to 25 mm.

Preferably, the light transmittance (Tce) at the edge, i.e., the end, of the effective screen of the panel 1 is in the range 20% to 40%, and the ratio (Tce/Tp) of the light transmittance at the edge to the light transmittance at the central portion of the panel 1 is in the range of 0.55 to 0.65.

Further, the wedge ratio (Rw), which denotes the ratio of the thickness of the edge of the panel 1 and the thickness of the central portion of the panel 1 is preferably in the range of 200% to 270%, and more preferably in the range of 203% to 225%.

By the above configuration, brightness uniformity (B/U), which denotes a difference of brightnesses between the central portion and the edge of the panel 1 is at least 50% without reducing the widths of the black matrix at the edge of the panel 1, thereby preventing deterioration of color purity. The above value of the B/U is higher than a value required by a general buyers, i.e., 47%.

A distance (OAH) between the central portion of the outer surface of the panel 1 and a contact surface of the panel 1 and the panel 2 is in the range of 75 mm to 95 mm, and preferably in the range of 81 mm to 87.7 mm, thereby reducing the breakdown of the panel 1 in the thermal treatment process and decreasing the weight of the panel 1.

In order to decrease the weight of the panel 1 applied to the color cathode ray tube of the present invention, a distance (Pz) between the stud pin 7, for fixing an assembly of the shadow mask 3 and the frame 5 to the panel 1, and the central portion of the inner surface of the panel 1 is adjusted.

In order to decrease the weight of the panel 1 by reducing the length of a skirt portion of the panel 1 obtained by bending the inner and outer surfaces of the panel 1 at an approximately right angle, the distance (Pz) between the stud pin 7 and the central portion of the inner surface of the panel 1 is in the range of 40 mm to 60 mm, and preferably in the range of 49 mm to 52.1 mm.

Only when the distance (Pz) between the stud pin 7 and the central portion of the inner surface of the panel 1 is more than 40 mm, the assembly of the shadow mask 3 and the frame 5 can be stably installed on the inner surface of the panel 1. However, when the distance (Pz) between the stud pin 7 and the central portion of the inner surface of the panel 1 exceeds 60 mm, the length of the skirt portion of the panel 1 is elongated, thereby reducing the light-weight and cost-reduction effects of the color cathode ray tube of the present invention.

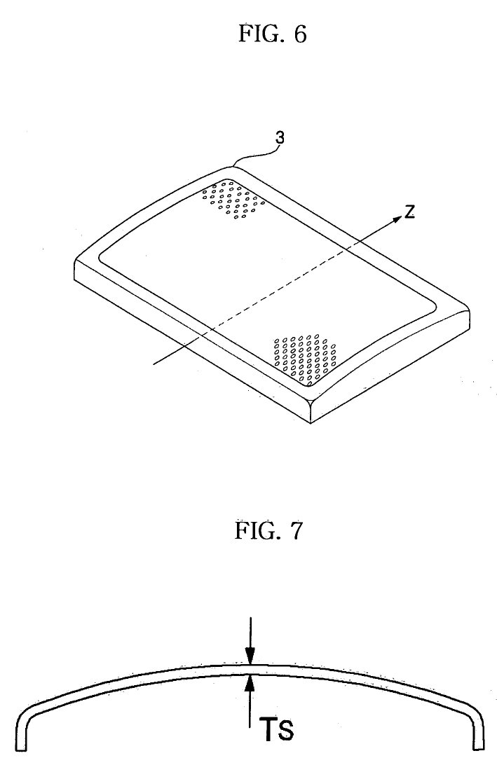

Hereinafter, FIGS. 6 and 7 will illustrate the shadow mask applied to the color cathode ray tube of the present invention.

FIG. 6 is a perspective view of the shadow mask applied to the color cathode ray tube of the present invention, and FIG. 7 is a sectional view of FIG. 6, taken along the “z” axis.

The shadow mask 3, which is applied to the color cathode ray tube of the present invention, is made of invar or ultra invar, and has a thickness (Ts) in the range of 0.19 mm to 0.21 mm (i.e., 0.19 mm≦Ts≦0.21 mm).

The shadow mask 3, which is applied to the conventional color cathode ray tube, is made of invar and has a thickness of at least 0.22 mm. However, the shadow mask 3, which is applied to the color cathode ray tube of the present invention, has a thickness (Ts) in the range of 0.19 mm to 0.21 mm so as to optimize the curvature. Therefore, the shadow mask 3 of the present invention easily undergoes an etching process for forming slots compared to the conventional shadow mask 3, and reduces costs due to the reduction in the thickness thereof.

As apparent from the above description, the present invention provides a color cathode ray tube, which has improved structures of respective portions of a panel applied thereto, including a thickness of the central portion of the panel, thereby decreasing the weight of the panel, reducing thermal damage generated in a cathode ray tube manufacturing process, and improving brightness characteristics of the panel.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A color cathode ray tube comprising:
a front panel, an outer surface of which is flat and an inner surface of which has a designated curvature;
a rear panel installed on a rear part of the front panel for forming vacuum therein;
an electron beam gun inserted into a neck part of the rear panel for discharging an electron beam toward a screen;
a deflection yoke for scanning the electron beam, discharged from the electron beam gun, up, down, right, and left; and
a shadow mask, formed on the inner surface of the front panel, including a plurality of slots spaced from each other by a designated interval,
wherein a thickness (CFT) of a central portion of the front panel satisfies the below range:
9.0 mm≦CFT≦10.9 mm, and
a light transmittance (Tp) of the central portion of the front panel satisfies the below range:
50%≦Tp≦65%.

2. The color cathode ray tube as set forth in claim 1,
wherein the thickness (CFT) of the central portion of the front panel further satisfies the below range:
9.2 mm≦CFT≦10.3 mm.

3. The color cathode ray tube as set forth in claim 1,
wherein a thickness (Tf) of an end of an effective screen of the front panel satisfies the below range:
18.0 mm≦Tf≦26.0 mm.

4. The color cathode ray tube as set forth in claim 3,
wherein the thickness (Tf) of the end of the effective screen of the front panel further satisfies the below range:
20 mm≦Tf≦25 mm.

5. The color cathode ray tube as set forth in claim 1,
wherein a distance (OAH) between a central portion of the outer surface of the front panel and a contact portion of the front and rear panels satisfies the below range:
75 mm≦OAH≦95 mm.

6. The color cathode ray tube as set forth in claim 5,
wherein the distance (OAH) between the central portion of the outer surface of the front panel and the contact portion of the front and rear panels further satisfies the below range:
81 mm≦OAH≦87.7 mm.

7. The color cathode ray tube as set forth in claim 1,
wherein a distance (Pz) between a stud pin, for connecting the front panel and a frame supporting the shadow mask, and a central portion of the inner surface of the front panel satisfies the below range:
40 mm≦Pz≦60 mm.

8. The color cathode ray tube as set forth in claim 7,
wherein the distance (Pz) between the stud pin, for connecting the front panel and the frame supporting the shadow mask, and the central portion of the inner surface of the front panel further satisfies the below range:
49 mm≦Pz≦52.1 mm.

9. The color cathode ray tube as set forth in claim 1,
wherein a wedge ratio (Rw), denoting the ratio of the thickness of the edge of the front panel to the thickness of the central portion of the front panel satisfies the below range:
200%≦Rw≦270%.

10. The color cathode ray tube as set forth in claim 9,
wherein the wedge ratio (Rw), denoting the ratio of the thickness of the edge of the front panel to the thickness of the central portion of the front panel further satisfies the below range:
203%≦Rw≦225%.

11. The color cathode ray tube as set forth in claim 1,
wherein a light transmittance (Tce) at an edge of the front panel satisfies the below range:
20%≦Tce≦40%.

12. The color cathode ray tube as set forth in claim 11,
wherein a ratio (Tce/Tp) of the light transmittance at the edge of the front panel to the light transmittance at the central portion of the front panel satisfies the below range:
0.55≦Tce/Tp≦0.65.

13. The color cathode ray tube as set forth in claim 1,
wherein the shadow mask is made of invar.

14. The color cathode ray tube as set forth in claim 13,
wherein a thickness (Ts) of the shadow mask satisfies the below range:
0.19mmm≦Ts≦0.21 mm.

15. The color cathode ray tube as set forth in claim 1,
wherein the shadow mask is made of ultra invar.

16. The color cathode ray tube as set forth in claim 15,
wherein a thickness (Ts) of the shadow mask satisfies the below range:
0.19 mm≦Ts≦0.21 mm.
